(19) United States
(12) Patent Application Publication
(10) Pub. No.: US 2015/0285320 A1
(43) Pub. Date: Oct. 8, 2015

(54) SELECTABLE ONE-WAY AND/OR DOG CLUTCH ASSEMBLY

(71) Applicant: Robert H.F. Lloyd, Los Altos, CA (US)

(72) Inventor: Robert H.F. Lloyd, Los Altos, CA (US)

(21) Appl. No.: 14/246,139

(22) Filed: Apr. 6, 2014

(51) Int. Cl. F16D 41/08; F16D 15/00

(52) U.S. Cl. CPC F16D 41/084; F16D 15/00

(57) ABSTRACT

A sprag clutch assembly is provided for use within a hydro-mechanical vehicle transmission. The assembly provides for high packaging density of the transmission by allowing the related hydraulic devices to be located on the same side of the clutch assembly. An actuator causes the clutch to be engaged or dis-engaged. One version of the clutch can be designed either as a non-slip clutch or a one-way clutch. A second version of the clutch can be both a one way clutch and a non-slip clutch.

### RELATED APPLICATIONS

This application relates to and claims any and all benefits of U.S. provisional application No. 61/897,753 titled SELECTABLE ONE-WAY & DOG CLUTCH inventor ROBERT HUGH FRANCIS LLOYD filed Oct. 31, 2013.

### BACKGROUND OF THE INVENTION

With a road vehicle transmission, the input shaft is driven by the vehicle's engine and the output shaft drives the vehicles wheels. With a hydro-mechanical transmission using hydraulic regenerative braking, it is desirable for the transmission to be able to operate in three modes. One where the output shaft is operating at various speed in relation to the input shaft, one where the output shaft is locked to the input shaft in a mode known as direct drive (common in truck transmissions), and one where the output shaft is driven directly by the input shaft when driving the vehicles and disconnected when the vehicle is decelerating or braking. This clutch is intended for a transmission that contains two or more rotating hydraulic devices attached through gears to the input shaft and two or more rotating hydraulic devices attached to the output shaft. In order to obtain the necessary mechanical packaging density, it is required that all the hydraulic devices be on the same side of the clutch in the axial direction.

### SUMMARY OF THE INVENTION

The clutch is based on slide-able extension of the transmission input shaft that connects to a disc with conical surfaces on one or both sides of the disc. This disc is in a housing that is connected on one side to the transmission output shaft and on the other to a cylindrical shaft that encompasses coaxially the slide-able extension of the input shaft and is able to be attached to the output hydraulic devices though gears. The inside of the disc housing has conical surfaces on one or both sides that are parallel to the conical surfaces on the clutch plate. A annular assembly of sprags allowing only one-way engagement may be mounted on one of the conical surfaces of the disc housing. A sprag assembly organized to prevent relative motion of the clutch plate and housing in either direction when engaged would create a non-slip clutch.

### BRIEF DESCRIPTION OF THE DRAWINGS

FIG. 1 describes the relative physical location of the components in a transmission using the subject clutch.

FIG. 2 is a cross section drawing of the components of FIG. 1.

FIG. 3 is a detailed cross section drawing of the version of the clutch assembly that can be both a non-slip and a one-way clutch.

FIG. 4 illustrates how the sprags are located between the two conical engagement surfaces of the one-way clutch.

FIG. 5 illustrates how the sprags are arranged for a non-slip clutch.

### DESCRIPTION OF THE PREFERRED EMBODIMENTS

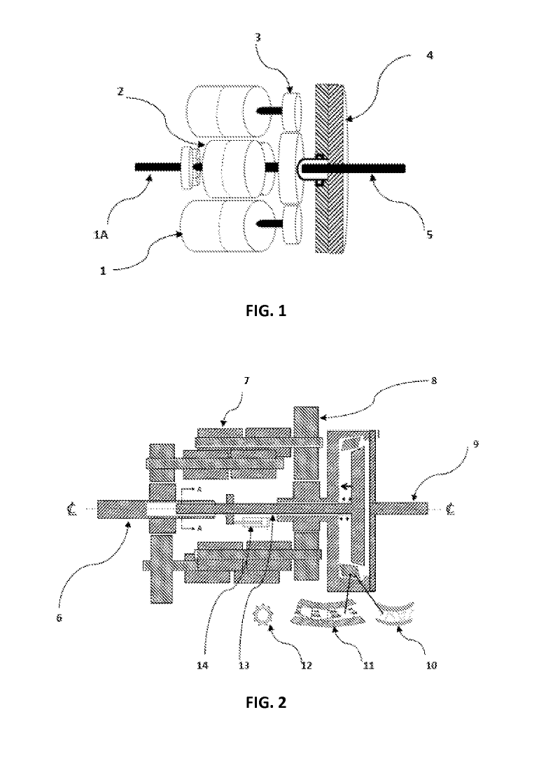

FIG. 1 illustrated the physical arrangement of the basic components of a hydro-mechanical transmission using the features of this invention. The invention allows the input hydraulic devices 2 to be located on the same side of the clutch 4 as the output hydraulic devices 1 thereby achieving a smaller overall size. Input shaft 1A can be connect to the output shaft 5 by means of the clutch 4. Output devices 1 are connected to the output shaft 5 with gears 3.

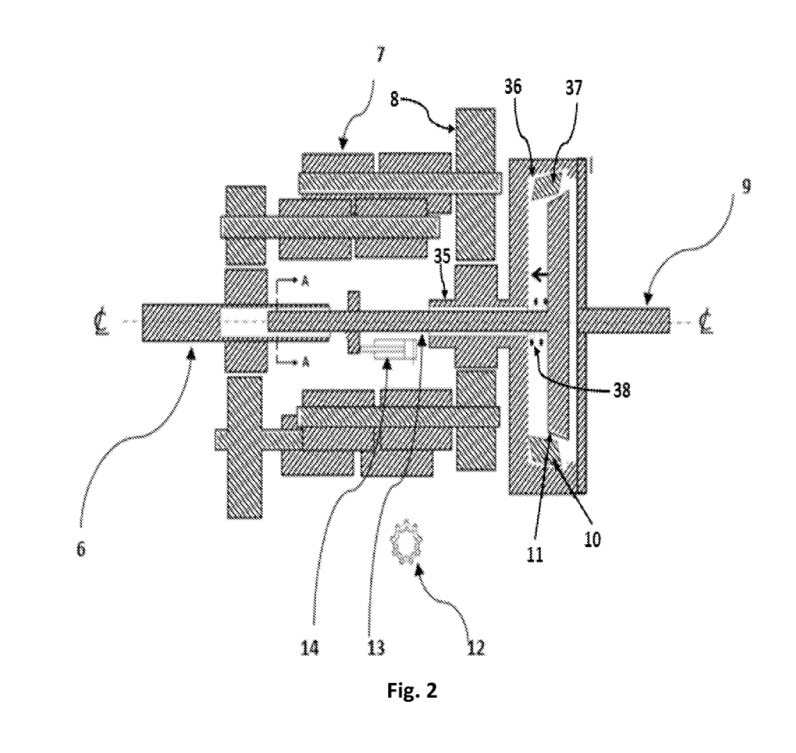

FIG. 2 is a cross-section detail of the components in FIG. 1. Input shaft 6 is connected by a slide-able, splined, concentric connection to an extension 13 which forms one side of the sprag clutch. Output shaft 9 is one with the outside casing of the clutch. Electrically or hydraulically powered actuator 14 will cause input shaft extension 13 to move axially thereby engaging or dis-engaging the clutch. If electrically operated, the actuator could be implemented with a solenoid. If hydraulically actuated, it could be in the form of a piston in a cylinder. When the clutch is engaged by moving the input shaft extension 13, sprags 10, 37 provide an interference fit between the conical clutch surfaces 36 and 11. 12 illustrates the A-A cross-section of the splined joint between the input shaft 6 and input shaft extension 13. Output hydraulic devices 7 are connected to the output shaft 35 through gear 8. Spring 38 will cause the clutch to disengage when allowed by the actuator 14.

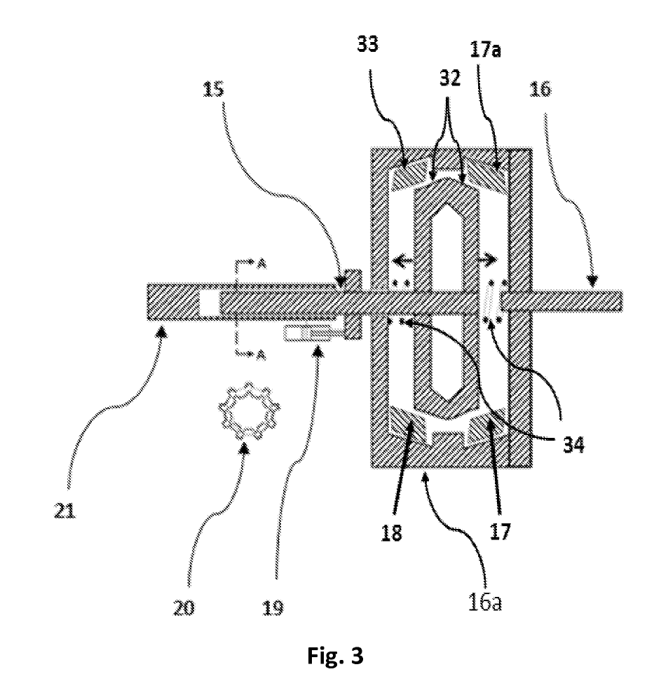

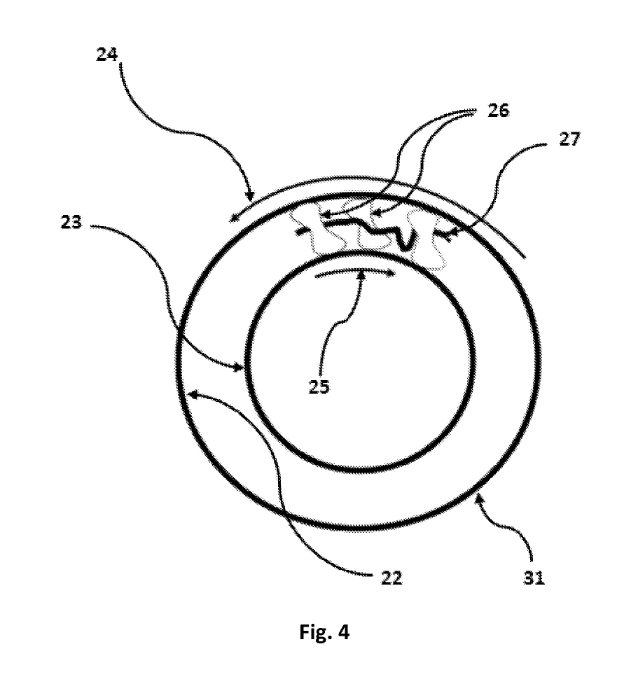

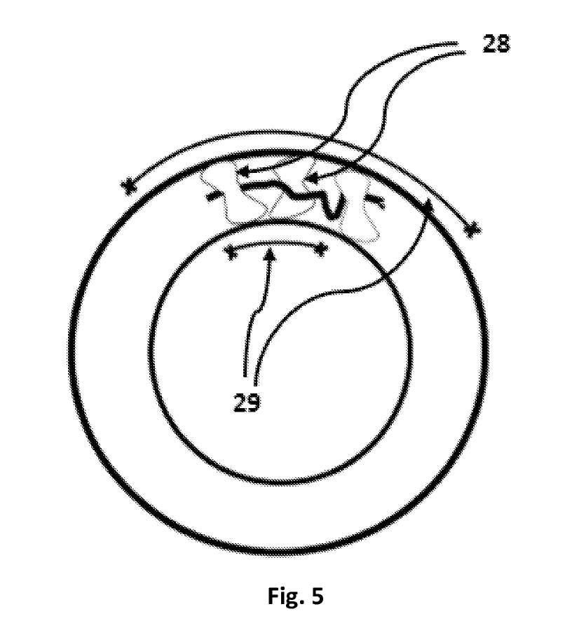

FIG. 3 is a detail of the clutch wherein the input 21 can connected to the output shaft 16 either as a one-way clutch 18 (See FIG. 4) or a non-slip clutch 17 (See FIG. 5) by means of a bi-directional, axial actuator 19. One side of the clutch 15 is an extension of the input shaft 21 through splined joint A-A 20. The clutch plate has two conical engagement surfaces 32. The sprags 33 and 18 could be the one-way clutch, then sprags 17, & 17a would be alternatively opposing to form a non-slip clutch. Springs 34 are used to keep the clutch in the dis-engaged position when not acted upon by the actuator 19. The case of the clutch 16a is integral with the output shaft 16.

FIG. 4 illustrates how the sprags 26 are aligned to form a one-way clutch. When the clutch is engaged, the sprags are in contact both with the conical engagement surface 22 of the clutch case 16a and 31 and conical engagement surface of the clutch plate 23. The sprags are help in position by a annular spring arrangement 27. 24 and 25 indicate the relative direction of motion allowed by the sprags.

The sprags 28 in FIG. 5 are aligned such that they oppose relative motion in either direction 29 resulting in a non-slip clutch.

What is claimed is:

1. A controllable and selectable one-way or non-slip hydro-mechanical transmission clutch that allows essentially all the other transmission components to be located on the same side of the clutch in the axial direction comprising;
a, an extendable input shaft connected to a clutch plate with a conical shaped engagement surface; and
b, a housing for the clutch plate connected to the output shaft of the clutch with a conical engagement surface on the internal face of the housing facing and parallel to the conical engagement surface on the clutch plate; and
c, a cylindrical extension of the output shaft connected to the housing of the clutch plate on the opposite side of the housing from the output shaft and concentric to the input shaft and of sufficient length to allow the attachment of other transmission components and free to rotate independently of the input shaft; and
d, a annular assembly of sprags located on the engagement surface of the conical face of the housing aligned such that its engagement surfaces are parallel to both the engagement surface on the housing and the clutch plate; and
e, the sprags arranged either alternatively apposing each other so as to form a non-slip clutch when engaged or aligned similarly to each other so as to create a one-way clutch when engaged; and
f, a remotely controlled actuator to cause the extendable input shaft to extend or shorten so as to cause the attached clutch plate to engage or disengage with the sprags and therefore the conical surface of the housing thereby engaging or disengaging the clutch.

2. A controllable and selectable one-way and non-slip hydro-mechanical transmission clutch that allows essentially all the other transmission components to be located on the same side of the clutch in the axial direction comprising;
a, an extendable input shaft connected to a single clutch plate with a conical shape engagement surface on both sides of the plate; and
b, a housing for the clutch plate connected to the output shaft of the clutch with conical engagement surfaces on both internal faces of the housing parallel to the conical surfaces on both sides of the clutch plate; and
c, a cylindrical extension of of the output shaft connected to the housing of the clutch plate on the opposite side of the housing from the output shaft and concentric to the input shaft and of sufficient length to allow the attachment of other transmission components and free to rotate independently of the input shaft; and
d, two annular assemblies of sprags located on both engagement surfaces of the housing and aligned such that their engagement surfaces are parallel to both the engagement surfaces on the housing and the clutch plate; and
e, the sprags arranged alternatively apposing each on one surface of the housing so as to form a non-slip clutch when engaged and aligned similarly to each other on the other engagement surface of the housing so as to create a one-way clutch when engaged; and
f, a remotely controlled actuator to cause the extendable input shaft to extend or shorten in so as to cause the attached clutch plate to engage or disengage with the sprags and therefore the conical surfaces of the housing thereby engaging or disengaging the clutch either as a non-slip clutch or a one-way clutch.
